(19) United States
(12) Patent Application Publication
(10) Pub. No.: US 2026/0056062 A1
(43) Pub. Date: Feb. 26, 2026

(54) ADDITIVE MANUFACTURED DUAL MATERIAL BRAZE JOINT REPLACEMENT

(71) Applicant: Rosemount Aerospace Inc., Burnsville, MN (US)

(72) Inventor: Joseph Weikert, Mendota Heights, MN (US)

(21) Appl. No.: 18/815,211

(22) Filed: Aug. 26, 2024

(51) Int. Cl. G01K 1/08; B33Y 80/00; G01K 1/14

(52) U.S. Cl. CPC G01K 1/08; G01K 1/14; B33Y 80/00; G01K 2205/00

(57) ABSTRACT

A temperature sensor may include a baseplate and a housing. The baseplate may include a rim portion with a top surface. The housing may include a strut portion with a bottom lip. The bottom lip may abut to and be one of fused to the top surface by a fusion zone or brazed to the top surface by a braze joint. The temperature sensor may include a fusion zone fusing the bottom lip and the top surface or a braze joint brazing the bottom lip and the top surface. A portion of or an entirety of the top surface of the rim portion may be utilized in the fusion zone or the braze joint. The bottom lip may include a lattice which improves the wetting of the braze joint.

### TECHNICAL FIELD

The present disclosure generally relates to air data probes of an aircraft, and more particularly to joints of the air data probes.

### BACKGROUND

Temperature sensors include a strut-to-baseplate joint. The strut-to-baseplate joint is an important structural element for the temperature sensor. The strut-to-baseplate joints are formed as a braze joint. The quality of the braze joint can be influenced by factors such as braze-gap sizing, part cleanliness, heat application, and operator technique. Forming the braze joint is a variable process that requires skilled operators to complete. The braze joint may suffer from strength issues stemming from inadequate braze liquation and wetting. The braze joint may also result in liquation of an alloy from which the braze is formed. Therefore, it would be advantageous to provide a device, system, and method that cures the shortcomings described above.

### SUMMARY

In some aspects, the techniques described herein relate to a temperature sensor including: a baseplate including a rim portion and a shoulder portion, wherein the shoulder portion is smaller than and axially extends from the rim portion, wherein the rim portion includes a top surface, wherein the rim portion and the shoulder portion define a centered-through hole, wherein the baseplate is made of a first base metal; a housing including a strut portion, wherein the strut portion defines a probe outlet and a sensor cavity, wherein the probe outlet and the sensor cavity are fluidically coupled within the housing, wherein the strut portion includes a bottom lip, wherein the housing is made of a second base metal, wherein the housing is formed with a plurality of layers, wherein the plurality of layers are stacked axially from the baseplate up to a distal end of the housing; and a sensor assembly, wherein the sensor assembly is disposed within the centered-through hole and the sensor cavity, wherein the sensor assembly is configured to generate a temperature measurement; wherein the bottom lip abuts and is fused to the top surface by a fusion zone.

In some aspects, the techniques described herein relate to a temperature sensor, wherein only a portion of the top surface is fused to the bottom lip by the fusion zone.

In some aspects, the techniques described herein relate to a temperature sensor, wherein an entirety of the top surface is fused to the bottom lip by the fusion zone, wherein the rim portion defines a plurality of offset-through holes, wherein the bottom lip defines a plurality of additional offset-through holes, and wherein the plurality of offset-through holes and the plurality of additional offset-through holes are coincident.

In some aspects, the techniques described herein relate to a temperature sensor, wherein the fusion zone is an alloy of the first base metal and the second base metal, and wherein the fusion zone does not include any metal other than the first base metal and the second base metal.

In some aspects, the techniques described herein relate to a temperature sensor, wherein a depth of the fusion zone is greater than 250 micrometers.

In some aspects, the techniques described herein relate to a temperature sensor, wherein the bottom lip is one of an annular oval, an annular circle, an annular airfoil, or an annular symmetric-lens.

In some aspects, the techniques described herein relate to a temperature sensor, wherein the first base metal is different than the second base metal.

In some aspects, the techniques described herein relate to a temperature sensor, wherein the temperature sensor is a total air temperature sensor, wherein the housing includes a scoop portion, wherein the scoop portion extends from the strut portion, wherein the strut portion is disposed between the scoop portion and the baseplate, wherein the scoop portion defines a scoop inlet, a scoop outlet, and a scoop cavity, wherein the scoop inlet, the scoop outlet, the probe outlet, the sensor cavity, and the scoop cavity are fluidically coupled within the housing, and wherein the sensor assembly is configured to generate a total air temperature measurement.

In some aspects, the techniques described herein relate to a temperature sensor, wherein the temperature sensor is an outside air temperature sensor, wherein the strut portion includes a strut inlet, wherein the bottom lip and the strut inlet are disposed at opposing ends of the strut portion, wherein the probe outlet, the sensor cavity, and the strut inlet are fluidically coupled within the housing, and wherein the sensor assembly is configured to generate an outside air temperature measurement.

In some aspects, the techniques described herein relate to a temperature sensor, wherein the temperature sensor is an engine temperature sensor, and wherein the sensor assembly is configured to generate an engine temperature measurement.

In some aspects, the techniques described herein relate to a temperature sensor including: a baseplate including a rim portion and a shoulder portion, wherein the shoulder portion is smaller than and axially extends from the rim portion, wherein the rim portion includes a top surface, wherein the rim portion and the shoulder portion define a centered-through hole, wherein the baseplate is made of a first base metal; a housing including a strut portion, wherein the strut portion defines a probe outlet and a sensor cavity, wherein the probe outlet and the sensor cavity are fluidically coupled within the housing, wherein the strut portion includes a bottom lip, wherein the housing is made of a second base metal, wherein the housing is formed with a plurality of layers, wherein the plurality of layers are stacked axially from the baseplate up to a distal end of the housing; and a sensor assembly, wherein the sensor assembly is disposed within the centered-through hole and the sensor cavity, wherein the sensor assembly is configured to generate a temperature measurement; wherein the bottom lip abuts and is brazed to the top surface by a braze joint, wherein the braze joint includes a filler metal, wherein the braze joint does not form an alloy with the first base metal and the second base metal, wherein the bottom lip includes a lattice structure, wherein the lattice structure is formed from a subset of the plurality of layers, wherein the lattice structure abuts and is brazed to the top surface by the braze joint, and wherein the braze joint fills the lattice structure.

In some aspects, the techniques described herein relate to a temperature sensor, wherein only a portion of the top surface is brazed to the bottom lip by the braze joint.

In some aspects, the techniques described herein relate to a temperature sensor, wherein an entirety of the top surface is brazed to the bottom lip by the braze joint, wherein the rim portion defines a plurality of offset-through holes, wherein the bottom lip defines a plurality of additional offset-through holes, and wherein the plurality of offset-through holes and the plurality of additional offset-through holes are coincident.

In some aspects, the techniques described herein relate to a temperature sensor, wherein the filler metal includes at least one of silver, aluminum, gold, copper, zinc, tin, nickel, or an alloy thereof.

In some aspects, the techniques described herein relate to a temperature sensor, wherein the lattice structure is open-cell.

In some aspects, the techniques described herein relate to a temperature sensor, wherein the bottom lip is one of an annular oval, an annular circle, an annular airfoil, or an annular symmetric-lens.

In some aspects, the techniques described herein relate to a temperature sensor, wherein the first base metal is different than the second base metal.

In some aspects, the techniques described herein relate to a temperature sensor, wherein the temperature sensor is a total air temperature sensor, wherein housing includes a scoop portion, wherein the scoop portion extends from the strut portion, wherein the strut portion is disposed between the scoop portion and the baseplate, wherein the scoop portion defines a scoop inlet, a scoop outlet, and a scoop cavity, wherein the scoop inlet, the scoop outlet, the probe outlet, the sensor cavity, and the scoop cavity are fluidically coupled within the housing, and wherein the sensor assembly is configured to generate a total air temperature measurement.

In some aspects, the techniques described herein relate to a temperature sensor, wherein the temperature sensor is an outside air temperature sensor, wherein the strut portion includes a strut inlet, wherein the bottom lip and the strut inlet are disposed at opposing ends of the strut portion, wherein the probe outlet, the sensor cavity, and the strut inlet are fluidically coupled within the housing, and wherein the sensor assembly is configured to generate an outside air temperature measurement.

In some aspects, the techniques described herein relate to a temperature sensor, wherein the temperature sensor is an engine temperature sensor, and wherein the sensor assembly is configured to generate an engine temperature measurement.

### BRIEF DESCRIPTION OF THE DRAWINGS

Implementations of the concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1A depicts a front-perspective view of a total air temperature sensor with a fusion zone which utilizes a portion of a top surface of a rim portion of a baseplate, in accordance with one or more embodiments of the present disclosure.

FIG. 1B depicts a rear-perspective view of the total air temperature sensor, in accordance with one or more embodiments of the present disclosure.

FIG. 1C depicts a cross-section view of the total air temperature sensor in accordance with one or more embodiments of the present disclosure.

FIG. 1D depicts a baseplate of the total air temperature sensor before a housing is fused on the baseplate, in accordance with one or more embodiments of the present disclosure.

FIG. 2 depicts a partial cross-section view of an aircraft with the total air temperature sensor, in accordance with one or more embodiments of the present disclosure.

FIG. 3A depicts a front-perspective view of the total air temperature sensor with a fusion zone which utilizes an entirety of the top surface of the rim portion, in accordance with one or more embodiments of the present disclosure.

FIG. 3B depicts a cross-section view of the total air temperature sensor in accordance with one or more embodiments of the present disclosure.

FIG. 4 depicts a flow diagram of a method of manufacturing the total air temperature sensor, in accordance with one or more embodiments of the present disclosure.

FIG. 5A depicts a front-perspective view of the total air temperature sensor with a bottom lip of a strut portion including a lattice structure, in accordance with one or more embodiments of the present disclosure.

FIG. 5B depicts a partial-front view of the total air temperature sensor, in accordance with one or more embodiments of the present disclosure.

FIG. 5C depicts a partial-front view of the bottom lip of the strut portion including the lattice structure, in accordance with one or more embodiments of the present disclosure.

FIG. 5D depicts a partial-bottom perspective view of the bottom lip of the strut portion including the lattice structure, in accordance with one or more embodiments of the present disclosure.

FIG. 6 depicts a flow diagram of a method of manufacturing the total air temperature sensor, in accordance with one or more embodiments of the present disclosure.

FIG. 7 depicts a front-perspective view of a total air temperature sensor, in accordance with one or more embodiments of the present disclosure.

FIG. 8 depicts a front-perspective view of a total air temperature sensor, in accordance with one or more embodiments of the present disclosure.

FIG. 9 depicts a front-perspective view of a total air temperature sensor, in accordance with one or more embodiments of the present disclosure.

FIG. 10 depicts a front-perspective view of a total air temperature sensor, in accordance with one or more embodiments of the present disclosure.

FIG. 11 depicts a front-perspective view of an outside air temperature sensor, in accordance with one or more embodiments of the present disclosure.

FIG. 12 depicts a front-perspective view of an engine temperature sensor, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details are set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Reference will now be made in detail to the subject matter disclosed, which is illustrated in the accompanying drawings. Embodiments of the present disclosure are generally directed to an additive manufactured dual material braze joint replacement. A temperature sensor may include a baseplate and a housing. The baseplate may include a rim portion with a top surface. The housing may include a strut portion with a bottom lip. The bottom lip may abut to and be one of fused to the top surface by a fusion zone or brazed to the top surface by a braze joint. The temperature sensor may include a fusion zone fusing the bottom lip and the top surface or a braze joint brazing the bottom lip and the top surface. A portion of or an entirety of the top surface of the rim portion may be utilized in the fusion zone or the braze joint. The bottom lip may include a lattice which improves the wetting of the braze joint.

U.S. Pat. No. 10,889,060B2, titled “Additively manufactured integrated handling protection”; U.S. Patent Publication Number US20240010344A1, titled “Air data probe electronics housing with thermal isolating features”; U.S. Patent Publication Number US20240010343A1, titled “Air data probe electronics housing with retention features”; U.S. Pat. No. 10,612,984B2, titled “Sensor aspiration utilizing hoop airflow induction”; U.S. Pat. No. 10,852,203B2, titled “Total air temperature probe with concave flow path transitions to outlet”; U.S. Pat. No. 10,203,253B2, titled “Total air temperature probe with efficient particle pass through”; U.S. Pat. No. 10,422,702B2, titled “Total air temperature probe with reduced icing sensor flow passage geometry”; U.S. Pat. No. 10,151,641B2, titled “Total air temperature probes for reducing deicing heater error”; U.S. Pat. No. 9,429,482B2, titled “Total air temperature probe with low frontal projected area”; U.S. Pat. No. 8,104,955B2, titled “Aspirated enhanced total air temperature probe”; U.S. Pat. No. 7,174,782B2, titled “Total air temperature probe providing a secondary sensor measurement chamber”; U.S. Pat. No. 9,689,755B2, titled “Temperature sensors”; are incorporated herein by reference in the entirety.

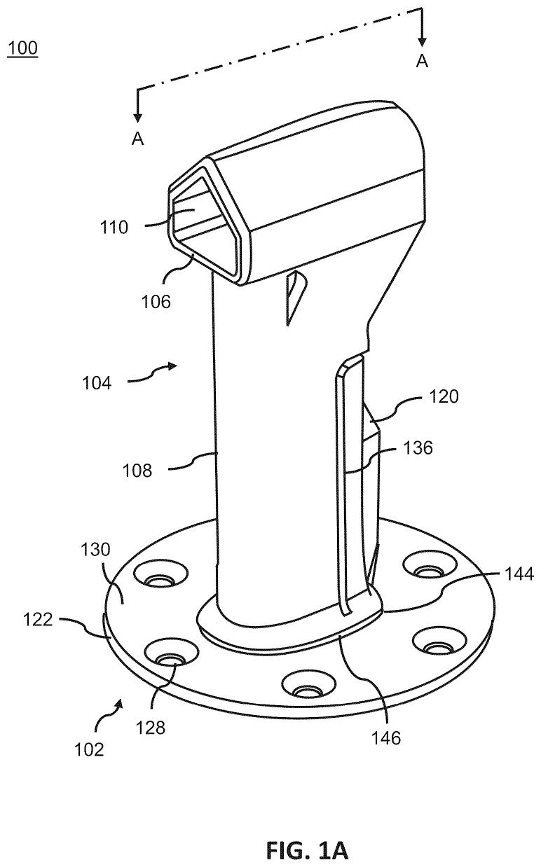

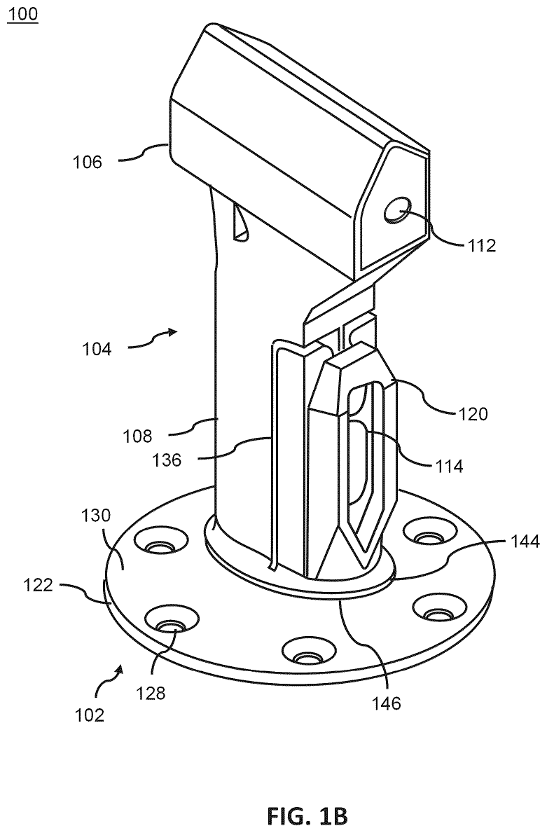

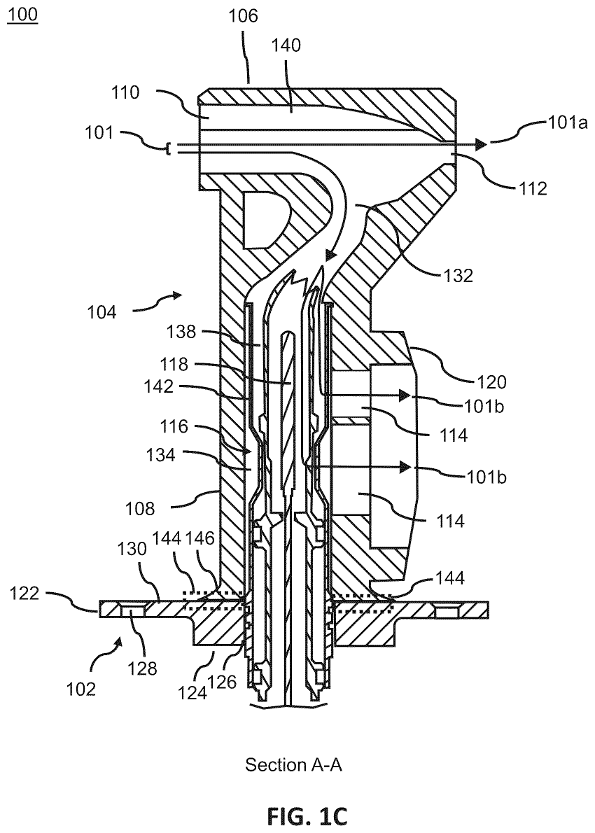

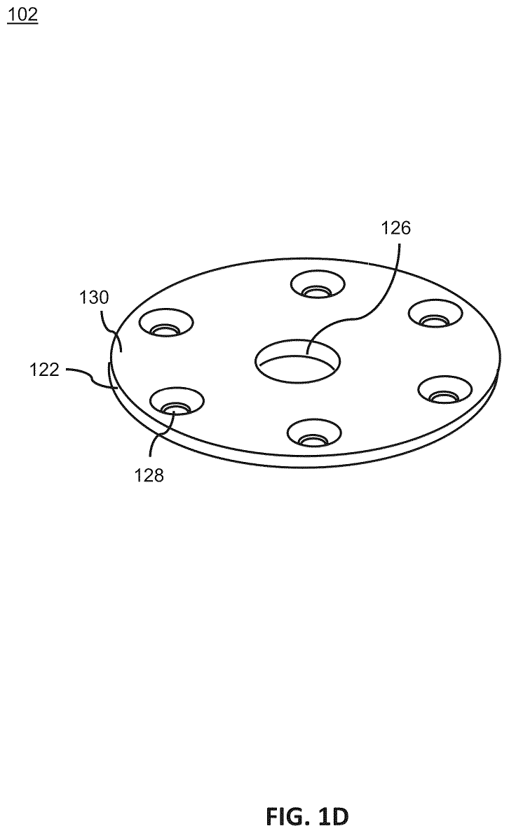

FIGS. 1A-1D depict a total air temperature sensor 100 (TAT sensor), in accordance with one or more embodiments of the present disclosure. The total air temperature sensor 100 may also be referred to as a total air temperature probe. The total air temperature sensor 100 may include a baseplate 102, a housing 104, and/or a sensor assembly 116.

The baseplate 102 may also be referred to as a flange or collar. The baseplate 102 may include a rim portion 122 and/or a shoulder portion 124. The rim portion 122 and/or the shoulder portion 124 may be circular. The rim portion 122 and/or the shoulder portion 124 may be bodies of revolution. For example, the rim portion 122 and/or the shoulder portion 124 may be bodies of revolution about a center axis of the baseplate 102. The rim portion 122 and/or the shoulder portion 124 may include circular cross-sections along the center axis of the baseplate 102. The shoulder portion 124 may be radially smaller than and axially extend from the rim portion 122.

The rim portion 122 may include a top surface 130. The top surface 130 may be planar. The top surface 130 may be flat along a horizontal plane. The top surface 130 may not include any significant curvature along the horizontal plane. The shoulder portion 124 may axially extend from an end of the rim portion 122 opposed to the top surface 130.

The rim portion 122 and/or shoulder portion 124 may define a centered-through hole 126. The centered-through hole 126 may be defined through the rim portion 122 and/or shoulder portion 124. The centered-through hole 126 may be coincident to the center axis of the baseplate 102.

The rim portion 122 may define offset-through holes 128. The offset-through holes 128 may be defined through the rim portion 122. The offset-through holes 128 may be radially offset from the center axis of the baseplate 102 and/or from the centered-through hole 126. The rim portion 122 may define any number of the offset-through holes 128. As depicted, the rim portion 122 defines six of the offset-through holes 128, although this is not intended to be limiting. The offset-through holes 128 may be defined in a select pattern. For example, the offset-through holes 128 may be defined in a polar array about the center axis and/or about the centered-through hole 126.

The centered-through hole 126 and the offset-through holes 128 may include any type of through hole, such as, but not limited to, plain through hole, a countersink through hole, a counterbore through hole, a counterdrill through hole (e.g., a countersink hole which is offset from the surface), or the like. As depicted, the centered-through hole 126 and the offset-through holes 128 are a plain through hole and a countersink through hole, respectively, although this is not intended to be limiting.

The housing 104 may also be referred to as a body. The housing 104 may include a scoop portion 106 and/or a strut portion 108. The scoop portion 106 may also be referred to as a head. The scoop portion 106 may extend from the strut portion 108. The strut portion 108 may be disposed between the scoop portion 106 and the baseplate 102.

The housing 104 may define a scoop inlet 110, a scoop outlet 112, a probe outlet 114, a flow-separation bend 132, a sensor cavity 134, a heater cavity 136, a scoop cavity 140, or the like. The scoop portion 106 may define the scoop inlet 110, the scoop outlet 112, and/or the scoop cavity 140. The strut portion 108 may define the probe outlet 114 and the sensor cavity 134. The scoop portion 106 and the strut portion 108 may collectively define the flow-separation bend 132 and/or the heater cavity 136. The scoop inlet 110, the scoop outlet 112, the probe outlet 114, the flow-separation bend 132, the sensor cavity 134, and/or the scoop cavity 140 may be fluidically coupled within the housing 104.

The scoop cavity 140 may also be referred to as a main airflow cavity. The scoop cavity 140 may fluidically couple between the scoop inlet 110 and the scoop outlet 112. The scoop cavity 140 may be a Venturi. For example, a size of the scoop cavity 140 may decrease from the scoop inlet 110 to the scoop outlet 112.

The flow-separation bend 132 may also be referred to as an inertial-separation bend. The flow-separation bend 132 may fluidically couple between the scoop cavity 140 and the sensor cavity 134. The flow-separation bend 132 may include a select shape. For example, the flow-separation bend 132 may be a U-bend. For example, the U-bend may include an angle of about 145 degrees.

The sensor cavity 134 may be radially aligned with and axially offset from the centered-through hole 126. The sensor cavity 134 may be a cylindrical cavity which is defined from a bottom surface of the strut portion 108 up to the flow-separation bend 132. The sensor cavity 134 may be orthogonal to the scoop cavity 140. The sensor cavity 134 may fluidically couple between the flow-separation bend 132 and the probe outlet 114.

The probe outlet 114 may be defined from a rear surface of the strut portion 108 through to the strut portion 108. The probe outlet 114 may be aspirated or non-aspirated. The strut portion 108 may include a hoop ejector 120 where the probe outlet 114 is aspirated and may not include the hoop ejector 120 where the probe outlet 114 is not aspirated. As depicted, the probe outlet 114 is aspirated and the strut portion 108 include the hoop ejector 120, although this is not intended to be limiting.

The total air temperature sensor 100 may experience harsh operating conditions including, but not limited to low operating temperatures, ice, rain, sleet, snow, and the like. Ice formation on the strut portion 108 may reduce the ability of the sensor assembly 116 to detect and relay information. The total air temperature sensor 100 may be heated to prevent rain, ice, or other moisture from attaching to the total air temperature sensor 100.

The heater cavity 136 may be configured to heat the housing 104. The heater cavity 136 may be defined along an outer surface of the housing 104. For example, the heater cavity 136 may be defined along the scoop portion 106 and/or the strut portion 108. The heater cavity 136 may be configured to heat the outer surface of the scoop portion 106 and/or the strut portion 108. The heat produced by the heater cavity 136 may hamper the formation of ice on the strut portion 108. The heater cavity 136 may use any suitable method of producing the heat. For example, the heater cavity 136 may use hot bleed air, electrical resistance heating, or the like to the produce heat.

The housing 104 may house one or more components of the total air temperature sensor 100. For example, the housing 104 may house the sensor assembly 116. The sensor assembly 116 may be disposed within the centered-through hole 126 and/or the sensor cavity 134.

The sensor assembly 116 may include one or more components, such as, sensor elements 118, a flow duct 138, and/or a flow liner 142. The sensor elements 118, the flow duct 138, and/or the flow liner 142 may be disposed within the sensor cavity 134. The sensor elements 118, the flow duct 138, and the flow liner 142 may be concentric.

The sensor assembly 116 may include any number of the sensor elements 118. The sensor assembly 116 may include at least one of the sensor elements 118. For example, the sensor assembly 116 may include two of the sensor elements 118. The sensor elements 118 and the probe outlet 114 may be axially aligned.

The sensor assembly 116 may be configured to generate a total air temperature measurement. For example, the sensor elements 118 of the sensor assembly 116 may be configured to generate the total air temperature measurement. The total air temperature measurement may also be referred to as a stagnation temperature measurement. The sensor elements 118 may include any suitable sensing element for generating the total air temperature measurement, such as, but not limited to, a wire-wound platinum-resistance device.

The flow duct 138 may house the sensor elements 118. The flow duct 138 may be coupled to the sensor elements 118. The flow duct 138 may be aligned with the flow-separation bend 132. The flow duct 138 may be curved to align with the flow-separation bend 132. A tip of the flow duct 138 may be castellated. The castellation may form a series of alternating peaks and valleys.

The flow liner 142 may house the flow duct 138. The flow liner 142 may couple the sensor assembly 116 to the baseplate 102 and/or the housing 104.

The housing 104 may also define bleed holes (not depicted). The bleed holes may remove warm boundary layer air and moisture that coalesces within the housing 104. The bleed holes may be defined from an outer surface of the housing 104 through to the flow-separation bend 132, the sensor cavity 134, and/or the scoop cavity 140.

The scoop inlet 110 may be a leading edge of the total air temperature sensor 100. The scoop outlet 112 and/or the probe outlet 114 may be a trailing edge of the total air temperature sensor 100. The scoop inlet 110 and the scoop outlet 112 may be positioned at a distal end of the housing 104 away from the baseplate 102. The probe outlet 114 may be disposed between the scoop portion 106 and the baseplate 102.

Air 101 and/or particles (not depicted) may be configured to flow through the scoop inlet 110 into the housing 104. The air 101 that flows into the housing 104 may exit the housing 104 through the scoop outlet 112 and/or the probe outlet 114. The air 101 that flows into the housing 104 may flow from the scoop inlet 110 to the scoop cavity 140. A first portion 101a of the air 101 may flow from the scoop cavity 140 and exit the housing 104 via the scoop outlet 112. A second portion 101b of the air 101 may flow from the scoop cavity 140, through the flow-separation bend 132, through the sensor cavity 134, pass by the sensor assembly 116, and exit the housing 104 via the probe outlet 114. Portions (not depicted) of the air 101 may exit the housing 104 via the bleed holes. The sensor assembly 116 may generate the total air temperature measurement based on the second portion 101b of the air 101 that passes by the sensor assembly 116.

The housing 104 may be formed with layers (not depicted). The layers may be stacked axially from the baseplate 102 up to the distal end of the housing 104 disposed away from the baseplate 102. The thickness of each of the layers may be on the order of tens to hundreds of micrometers. The interface between the layers may be a crystalline-grain boundary. The layers may be formed via additive manufacturing.

The housing 104 may be additively manufactured. For example, the housing 104 may be manufactured using a powder bed fusion additive manufacturing technique, such as selective laser melting (SLM), direct metal laser sintering (DMLS), laser metal printing, laser powder bed fusion (LPBF), electron beam melting (EBM), or the like.

The strut portion 108 may include a bottom lip 146. The bottom lip 146 may extend radially outwards. The bottom lip 146 may include a fillet (as-depicted) or a chamfer by which the bottom lip 146 extend radially outwards.

The housing 104 may abut and be fused to baseplate 102. The strut portion 108 may abut and be fused to the rim portion 122. For example, the bottom lip 146 may abut and be fused to the top surface 130 of the rim portion 122.

The strut portion 108 and the rim portion 122 may be fused by a fusion zone 144. The bottom lip 146 of the strut portion 108 and the top surface 130 of the rim portion 122 may be fused by the fusion zone 144. The fusion zone 144 may be an alloy of a base metal of the baseplate 102 and a base metal of the housing 104. The fusion zone 144 may not include any metal other than the base metal of the baseplate 102 and the base metal of the housing 104.

The baseplate 102 and/or housing 104 may be made of base metal. The base metal of the baseplate 102 may also be referred to as a first base metal. The base metal of the housing 104 may also be referred to as a second base metal. The base metal may be selected based on material availability, strength, fabricability, ability to fuse during additive manufacturing, or the like. The base metal may include, stainless steel, copper, a copper alloy (e.g., a beryllium-copper alloy), nickel, a nickel alloy (e.g., a Nickel 211), a nickel-chromium alloy (e.g., Alloy 600), or a combination thereof.

The base metal of the baseplate 102 may be different than the base metal of the housing 104. For example, the base metal of the baseplate 102 may be stainless steel or a nickel-chromium alloy. By way of another example, the base metal of the housing 104 may be nickel, copper, or an alloy thereof (e.g., nickel alloy, copper alloy).

The composition of the base metal of the baseplate 102 and the base metal of the housing 104 within the fusion zone 144 may be isotropic or anisotropic. The composition may be anisotropic along the radial length and/or the depth (e.g., axial length) of the fusion zone 144. For example, the composition within the fusion zone 144 of the base metal of the baseplate 102 may be higher closer to the baseplate 102 and the base metal of the housing 104 may be higher closer to the housing 104.

The fusion zone 144 may be formed as the housing 104 is additively manufactured. The additive process used to form the bottom lip 146 may also form the fusion zone 144. For example, heat from laser sintering a base metal powder used to form the housing 104 may melt the base metal of the rim portion 122 and the base metal powder. The base metal of the rim portion 122 and the base metal powder may mix and crystallize to form the fusion zone 144. The base metal of the baseplate 102 and the base metal of the housing 104 may not mix outside the fusion zone 144.

The fusion zone 144 may include a joint-effective volume. The joint-effective volume may be based on a depth of and a surface area of the fusion zone 144. Increasing the joint-effective volume may increase a shear strength of the fusion zone 144.

The fusion zone 144 may include a selected depth. The depth of the fusion zone 144 may be greater than 250 micrometers. The depth of the fusion zone may also be less than 1 mm. The depth of the fusion zone 144 may be based on a laser fluence used during when manufacturing the housing 104 and/or one or more material properties (e.g., latent heat of fusion) of the base metals of the baseplate 102 and/or the housing 104.

The fusion zone 144 may include a select surface area. The surface area of the fusion zone 144 may be based on a surface area of the bottom lip 146 of the strut portion 108.

In embodiments, the bottom lip 146 may be an annular oval. The annular oval may include an outer major diameter, an outer minor diameter, and/or an inner diameter. The outer major diameter, the outer minor diameter, and/or the inner diameter may define the surface area of the bottom lip 146 and/or the surface area of the fusion zone 144.

The outer major diameter may be larger than the outer minor diameter. The outer major diameter may be orthogonal to the outer minor diameter. The inner diameter may be less than the outer major diameter and less than the outer minor diameter. The outer major diameter and/or the outer minor diameter of the oval of the bottom lip 146 may be less than the diameter of the top surface 130 of the rim portion 122. In this example, the bottom lip 146 is disposed radially inwards of the outer diameter of the top surface 130 of the rim portion 122. Thus, only a portion of the top surface 130 is fused to the bottom lip 146 by the fusion zone 144. The fusion zone 144 may be printed on the portion of the top surface 130. Utilizing only the portion of the top surface 130 may be beneficial to reduce material cost of the bottom lip 146.

The outer major diameter may be aligned between the leading edge and the trailing edge of the total air temperature sensor. For example, the outer major diameter may be aligned between the scoop inlet 110 and the scoop outlet 112, and/or parallel to the scoop cavity 140. FIG. 1C depicts a cross-section through the major diameter. The alignment of the outer major diameter may be beneficial to improve the strength of the joint between the bottom lip 146 and the top surface 130 as the air 101 flows through the scoop inlet 110 and the scoop outlet 112.

The sensor cavity 134 may be defined through the bottom lip 146. The inner diameter may define the sensor cavity 134.

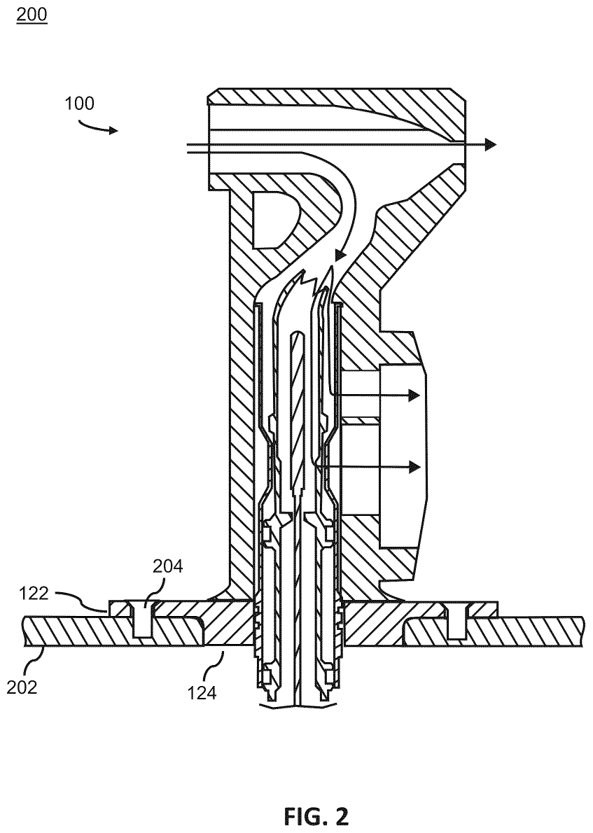

FIG. 2 depicts a partial cross-section view of an aircraft 200, in accordance with one or more embodiments of the present disclosure. The aircraft 200 may include the total air temperature sensor 100, a fuselage 202, and/or fasteners 204.

The fuselage 202 may also be referred to as a skin. The fuselage 202 may be a nose cone portion of the aircraft 200. The total air temperature sensor 100 may be positioned at the nose cone of the aircraft 200.

The total air temperature sensor 100 may be seated on and coupled to the fuselage 202. The baseplate 102 may seat the total air temperature sensor 100 on and couple to the fuselage 202. The rim portion 122 and the shoulder portion 124 may seat the total air temperature sensor 100 on the fuselage 202. A bottom surface of the rim portion 122 and/or an outer radius of the shoulder portion 124 may abut the fuselage 202. The bottom surface of the rim portion 122 may be opposed to the top surface 130.

The total air temperature sensor 100 may be positioned partially within the fuselage 202 and partially outside of the fuselage 202. The baseplate 102 may separate portions of the total air temperature sensor 100 positioned within and positioned outside of the fuselage 202. The shoulder portion 124 and portions of the sensor assembly 116 may be positioned within the fuselage 202. The rim portion 122 of the baseplate 102, the housing 104, and/or portions of the sensor assembly 116 may be positioned outside of the fuselage 202. For example, the scoop inlet 110, the scoop outlet 112, the probe outlet 114, and/or the sensor elements 118 may be positioned outside of the fuselage 202. The strut portion 108 may hold the scoop portion 106 away from the fuselage 202 to expose the scoop portion 106 to external airflow. Air from outside the aircraft 200 may flow through and/or along the scoop inlet 110, the scoop outlet 112, the probe outlet 114, and/or the sensor elements 118 and be measured.

Total air temperature measurements from the total air temperature sensor 100 may be communicated from the sensor assembly 116 to a computer (not depicted) of the aircraft 200. The computer may use the total air temperature measurements to generate air data parameters related to a flight condition of the aircraft 200.

The baseplate 102 and the fuselage 202 may be coupled. The rim portion 122 may couple the total air temperature sensor 100 to the fuselage 202. The baseplate 102 and the fuselage 202 may be coupled using any suitable coupling, such as, but not limited to, the fasteners 204, a weld, or the like. As depicted, the fasteners 204 couple the total air temperature sensor 100 to the fuselage 202. For example, the fasteners 204 may couple the total air temperature sensor 100 to the fuselage 202 via the offset-through holes 128. The fasteners 204 may include, but are not limited to, bolts, screws, rivets, or the like.

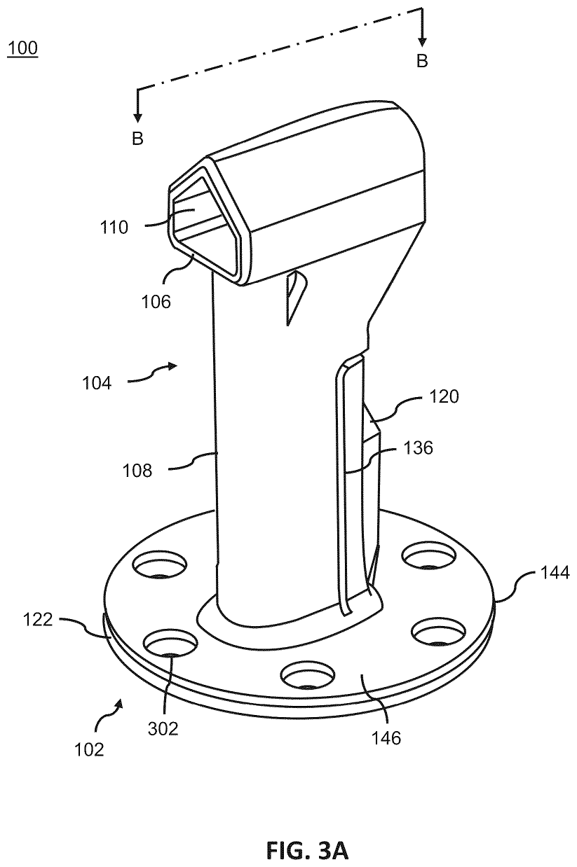

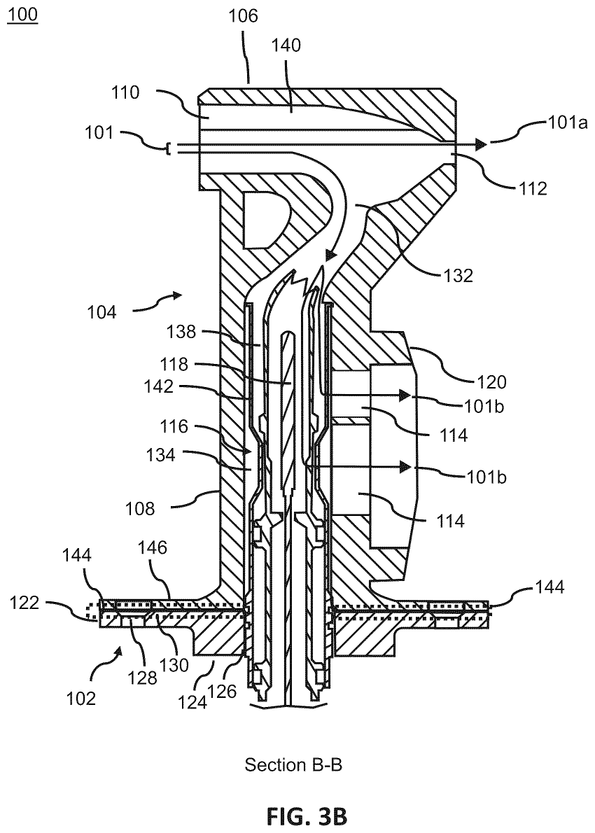

FIGS. 3A-3B depict the total air temperature sensor 100, in accordance with one or more embodiments of the present disclosure. Although the bottom lip 146 is described as an annular oval which is disposed radially inwards of the outer diameter of the top surface 130 of the rim portion 122 such that only the portion of the top surface 130 is used in the fusion zone 144, this is not intended as a limitation of the present disclosure.

In embodiments, the bottom lip 146 may be an annular circle. The annular circle may be radially aligned with an outer diameter of the top surface 130 or the rim portion 122. The annular circle may include an outer diameter and an inner diameter. The outer diameter of the annular circle and the outer diameter of the top surface 130 of the rim portion 122 may be radially aligned. In this example, the bottom lip 146 is radially aligned with the diameter of the top surface 130 of the rim portion 122. Thus, an entirety of the top surface 130 may be fused to the bottom lip 146 by the fusion zone 144. The fusion zone 144 may be printed on the entirety of the top surface 130. Utilizing the entirety of the top surface 130 may be beneficial to maximize the joint-effective volume of the fusion zone 144 and the strength of the fusion zone 144.

The bottom lip 146 may define additional offset-through holes 302. The additional offset-through holes 302 may be defined through the bottom lip 146.

The centered-through hole 126 and the offset-through holes 128 may include any type of through hole, such as, but not limited to, plain through hole, a countersink through hole, a counterbore through hole, a counterdrill through hole, or the like. For example, the additional offset-through holes 302 may be plain through holes.

The additional offset-through holes 302 may be coincident to the offset-through holes 128. The offset-through holes 128 and the additional offset-through holes 302 may collectively form a plain through hole, a countersink through hole, a counterbore through hole, a counterdrill through hole, or the like. As depicted, the offset-through holes 128 are countersink holes and the additional offset-through holes 302 are plain holes, such that the offset-through holes 128 and the additional offset-through holes 302 collectively form counterdrill holes, although this is not intended to be limiting.

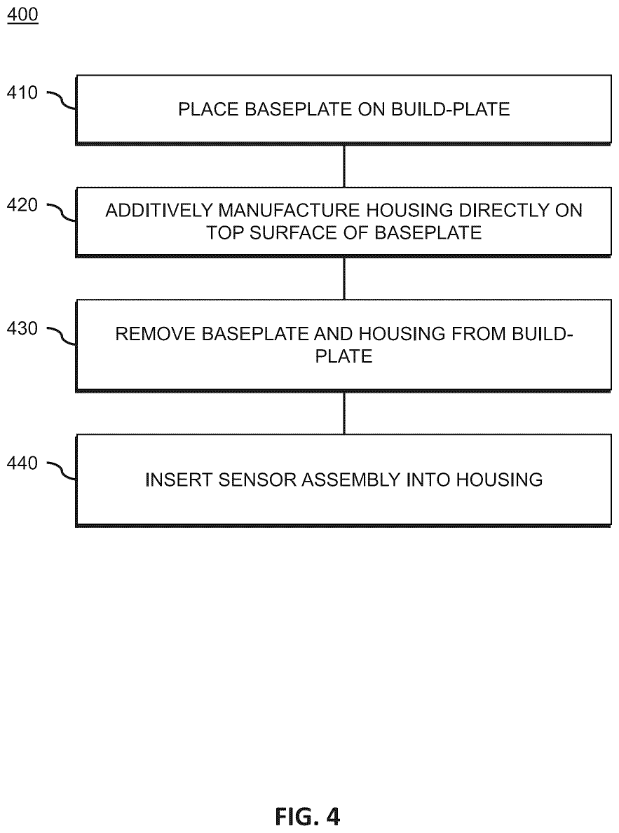

FIG. 4 depicts a flow diagram of a method 400, in accordance with one or more embodiments of the present disclosure. The method 400 may be a method of manufacturing the total air temperature sensor 100 with the fusion zone 144. The embodiments and enabling technologies described previously herein in the context of the total air temperature sensor 100 should be interpreted to extend to method 400. It is further noted, however, that the method 400 is not limited to the architecture of the total air temperature sensor 100.

In a step 410, the baseplate 102 is placed on a build-plate of an additive manufacturing machine (e.g., a laser bed powder fusion machine). The baseplate 102 is placed with the top surface 130 of the rim portion 122 facing upwards to be accessible for additive manufacturing.

In a step 420, the housing 104 is additively manufactured directly on the top surface 130 of the rim portion 122 of the baseplate 102. The bottom lip 146 may be the first portion of the housing 104 which is formed. The bottom lip 146 may be printed on the portion of or the entirety of the top surface 130. The fusion zone 144 may be formed as the rim portion 122 is formed. Utilizing the baseplate 102 as the build substrate on which the housing 104 is additively manufactured may provide the fusion zone 144 between the strut portion 108 and the baseplate 102. This may allow for consistent positioning between the strut portion 108 and baseplate 102, eliminating the need for the complex fixturing and high operator skill to complete the brazed joint. Overall, this step may serve to increase repeatability of the total air temperature sensor 100.

In a step 430, the baseplate 102 and the housing 104 are removed from the build-plate.

In a step 440, the sensor assembly 116 is inserted into the housing 104 via the centered-through hole 126 and coupled to the baseplate 102 and/or the housing 104.

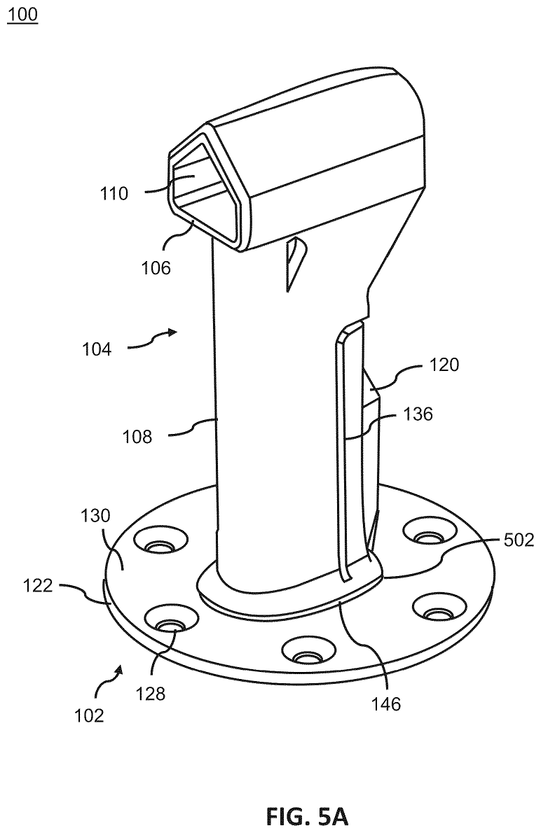

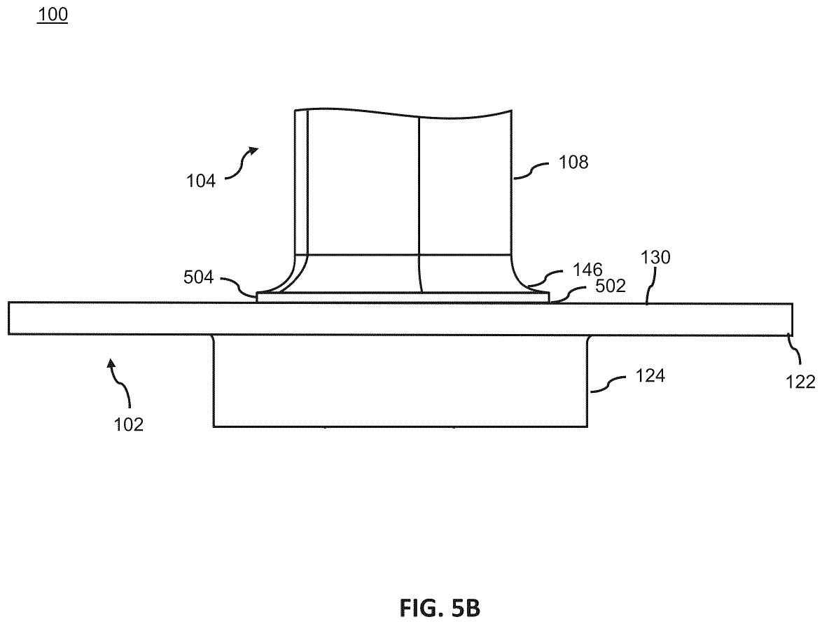

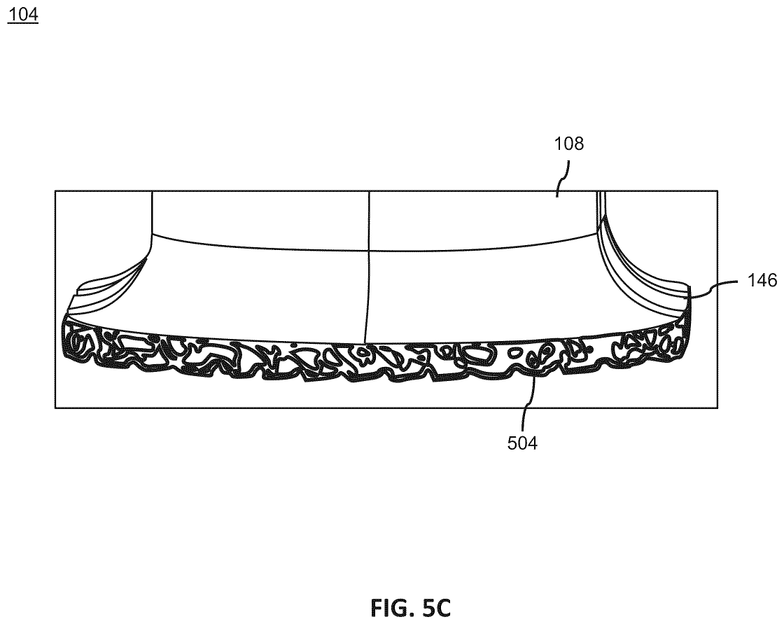

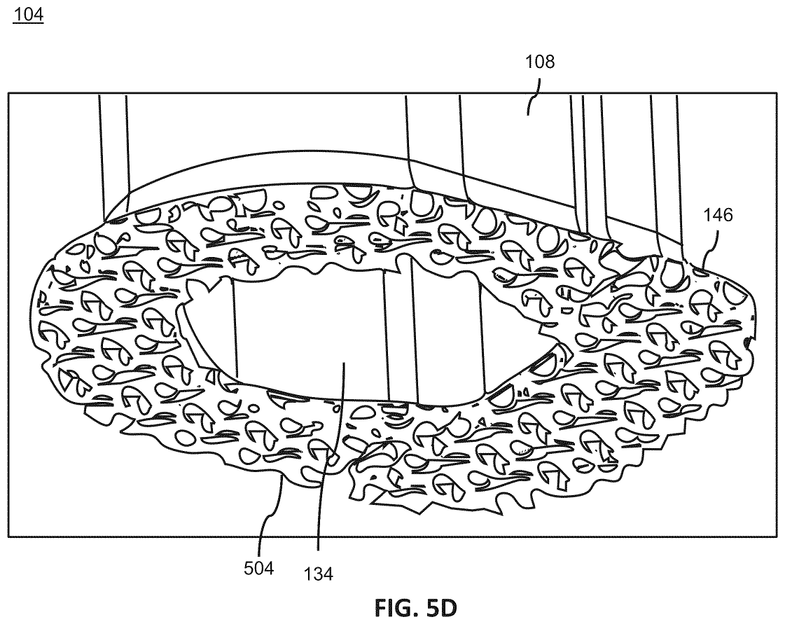

FIGS. 5A-5D depict the total air temperature sensor 100, in accordance with one or more embodiments of the present disclosure. Although the total air temperature sensor 100 is described as including the fusion zone 144 and the housing 104 is described as additively manufactured directly on the top surface 130 of the baseplate 102, this is not intended as a limitation of the present disclosure.

The housing 104 may be additively manufactured separately from and subsequently coupled to the top surface 130 of the baseplate 102 by a braze joint 502. The housing 104 may abut and be brazed to baseplate 102. The strut portion 108 may abut and be brazed to the rim portion 122. For example, the bottom lip 146 may abut and be brazed to the top surface 130 of the rim portion 122.

The strut portion 108 and the rim portion 122 may be joined by the braze joint 502. The bottom lip 146 of the strut portion 108 and the top surface 130 of the rim portion 122 may be joined by the braze joint 502. The braze joint 502 may be between the bottom lip 146 of the strut portion 108 and the top surface 130 of the rim portion 122. The braze joint 502 may be a lap joint between the bottom lip 146 of the strut portion 108 and the top surface 130 of the rim portion 122.

The braze joint 502 may include a filler metal. The filler metal may include one or more of silver, aluminum, gold, copper, zinc, tin, nickel, an alloy thereof, or another filler metal. For example, the filler metal may be a silver-copper alloy or other suitable braze alloys. The silver-copper alloy may be a binary alloy with only silver and copper or may include additional metals.

The braze joint 502 may not fuse and/or may not form an alloy with the base metal of the baseplate 102 and the base metal of the housing 104. The filler metal may include a melting point which is lower than the base metal of the baseplate 102 and the base metal of the housing 104. For example, the filler metal may not be heated sufficiently high to melt the base metal of the baseplate 102 and the base metal of the housing 104 when forming the braze joint 502.

The bottom lip 146 may also include a lattice structure 504. The lattice structure 504 may be made of the base metal of the housing 104. The lattice structure 504 may abut and be brazed to the top surface 130 by the braze joint 502. The sensor cavity 134 may be defined through the lattice structure 504.

The lattice structure 504 may be open-cell. The lattice structure 504 may be filled with the braze joint 502. The braze joint 502 may fill the lattice structure 504. The lattice structure 504 may allow the braze joint 502 to wet into the lattice structure 504 by being open-cell. For example, the filler metal of the braze joint 502 may wet into the lattice structure 504 when the filler metal is a liquid. The filler metal of the braze joint 502 may wet into the lattice structure 504 via a capillary action. The lattice structure 504 may provide a consistent braze gap with pores for the braze joint 502 to occupy. The wetting of the filler metal into the lattice structure 504 may also improve the wetting of the filler metal between the top surface 130 of the rim portion 122 and the bottom lip 146. The improvement to the wetting may provide improved joint strength for the braze joint 502 between the top surface 130 of the rim portion 122 and the bottom lip 146 of the strut portion 108.

The lattice structure 504 may be filled with the braze joint 502 to form the annular oval, the annular circle, or the like. As depicted, the lattice structure 504 and the braze joint 502 form the annular oval, although this is not intended to be limiting. The braze joint 502 may couple to the portion of the top surface 130 or couple to the entirety of the top surface 130. For example, the annular oval may couple to the portion of the top surface 130 and the annular circle may couple to the entirety of the top surface 130. Only a portion of the top surface 130 may be brazed to the bottom lip 146 by the braze joint 502. Alternatively, the entirety of the top surface 130 may be brazed to the bottom lip 146 by the braze joint 502.

The lattice structure 504 may include a select density, depth, and/or a geometric pattern. The density may include any fill percentage between about 10% and about 90%. The fill percentage may refer to the amount of the base metal of the housing 104 which makes up the lattice structure 504 during printing. The remainder of the lattice structure 504 may be voids which are filled by the braze joint 502. The depth of the lattice structure 504 may be on the order of millimeters to centimeters.

The lattice structure 504 may be a repeating geometric pattern of three-dimensional open-celled structures. The geometric pattern may repeat across the lattice structure 504.

The geometric pattern may include any suitable geometric pattern, such as, but not limited to, Bravais lattices (e.g., triangular lattices, rectangular lattices, hexagonal lattices, and the like), minimal surface lattices, or the like.

A minimal surface lattice may refer to a surface that locally minimizes the area of the surface. The minimal surface may be minimized according to one or more definitions. In embodiments, the minimal surface may be a triply periodic minimal surface (TPMS). Triply periodic minimal surfaces may refer to minimal surfaces which are periodic in three dimensions. The triply periodic minimal surfaces may be free from intersections. The triply periodic minimal surface may include, but are not limited to, gyroid, schwarz minimal surfaces, P-type minimal surfaces, and the like. As depicted, the geometric pattern of the lattice structure 504 is a gyroid, although this is not intended as a limitation of the present disclosure.

The lattice structure 504 may be formed from unit cells which repeat according to the geometric pattern. The lattice structure 504 may include one or more parameters which define the geometric pattern, such as, but not limited to, unit cell dimensions, (e.g., radius dimension, angular dimension, height dimension), unit cell repetitions (e.g., radius repetitions, angular repetitions, height repetitions), inner radius, wall thickness, outer diameter, and the like.

The lattice structure 504 may be formed with layers. The layers may be stacked axially. For example, the lattice structure 504 may be formed from a subset of the layers of the housing 104. The number of the subset from which the lattice structure 504 is formed may be based on the thickness of the layers and the thickness of the lattice structure 504.

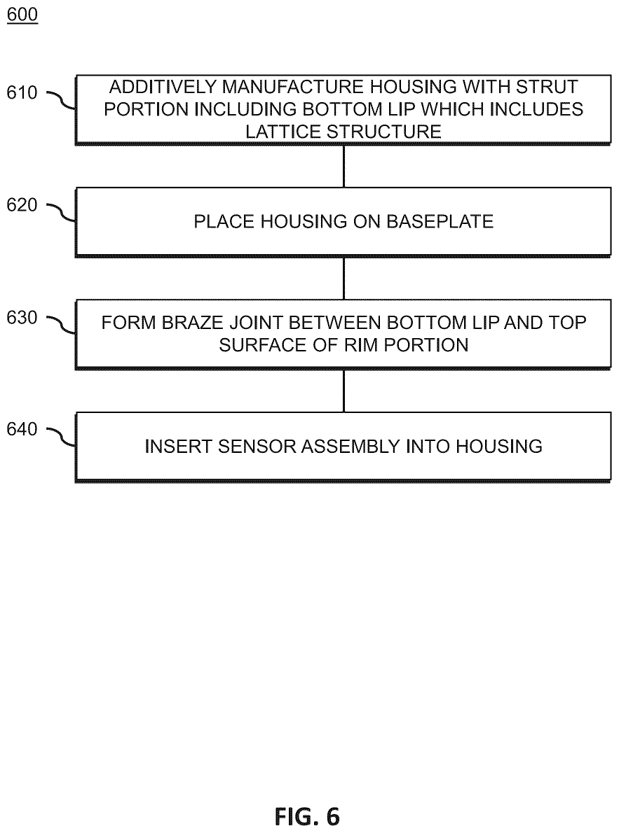

FIG. 6 depicts a flow diagram of a method 600, in accordance with one or more embodiments of the present disclosure. The method 600 may be a method of manufacturing the total air temperature sensor 100 with the braze joint 502 and the lattice structure 504. The embodiments and enabling technologies described previously herein in the context of the total air temperature sensor 100 should be interpreted to extend to method 600. It is further noted, however, that the method 600 is not limited to the architecture of the total air temperature sensor 100.

In a step 610, the housing 104 may be additively manufactured on a build-plate of the additive manufacturing machine. The housing 104 may be additively manufactured with the strut portion 108 including the bottom lip 146 which includes the lattice structure 504. The lattice structure 504 may be the first portion of the housing 104 which is formed.

In a step 620, the housing 104 is placed on the baseplate 102.

In a step 630, the braze joint 502 is formed between the bottom lip 146 and the top surface 130 of the rim portion 122. The braze joint 502 may be formed by heating a filler material thereby melting the filler material without melting the base metal of the housing 104 and without melting the base metal of the baseplate 102. The filler material may wet into the lattice structure 504 and between the bottom lip 146 and the top surface 130. The filler material may then crystallize to form the braze joint 502 without fusing to the bottom lip 146 and the top surface 130.

In a step 640, the sensor assembly 116 is inserted into the housing 104 via the centered-through hole 126 and coupled to the baseplate 102 and/or the housing 104.

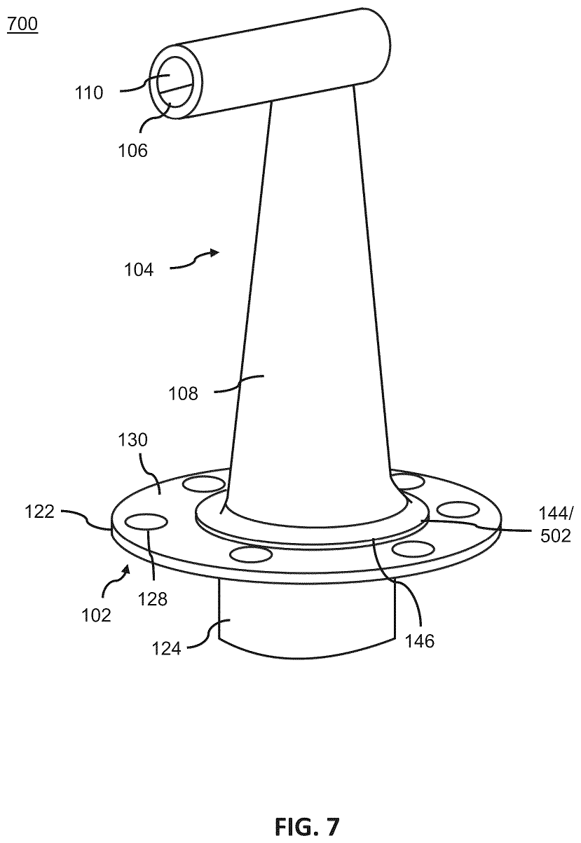

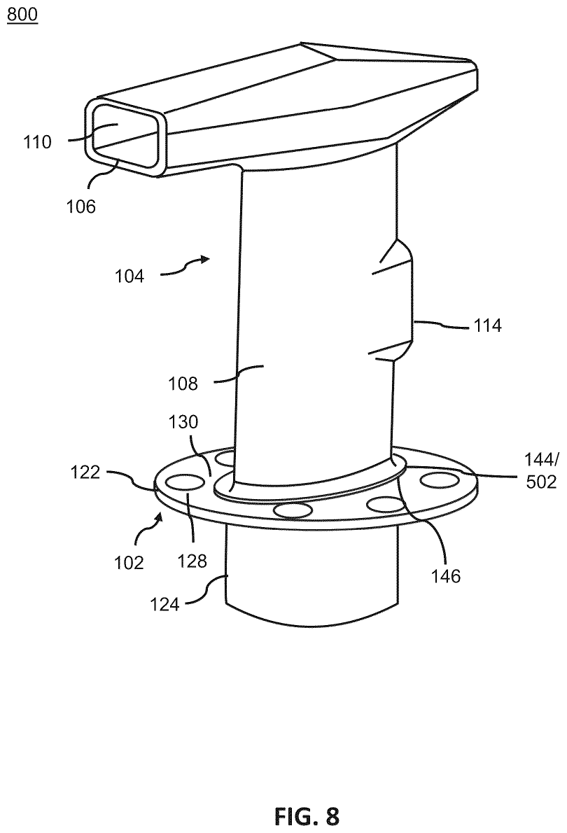

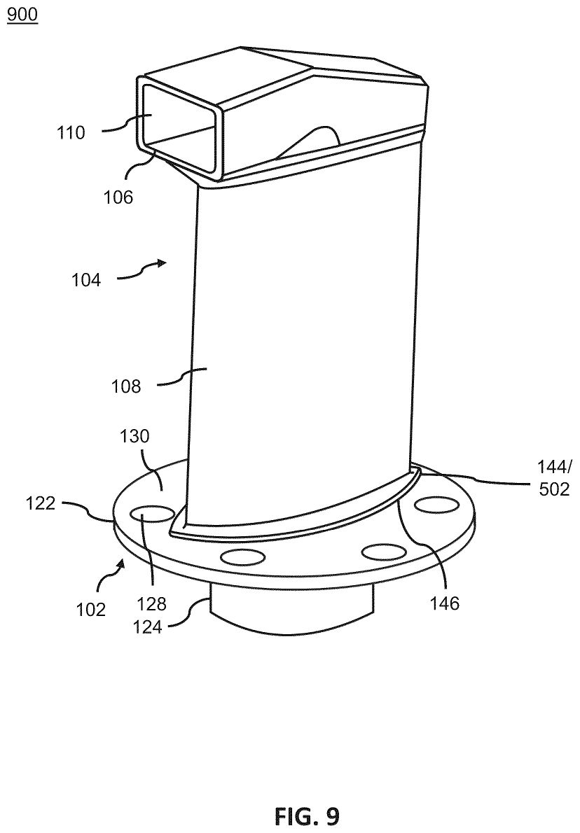

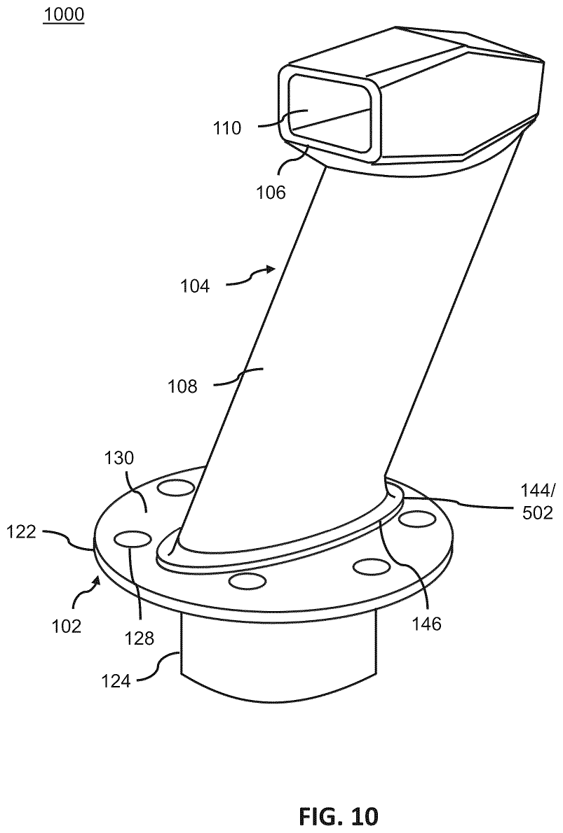

FIG. 7 depicts a total air temperature sensor 700, in accordance with one or more embodiments of the present disclosure. FIG. 8 depicts a total air temperature sensor 800, in accordance with one or more embodiments of the present disclosure. FIG. 9 depicts a total air temperature sensor 900, in accordance with one or more embodiments of the present disclosure. FIG. 10 depicts a total air temperature sensor 1000, in accordance with one or more embodiments of the present disclosure. The discussion of the total air temperature sensor 100 is incorporated herein by reference in the entirety as to the total air temperature sensor 700, the total air temperature sensor 800, the total air temperature sensor 900, and the total air temperature sensor 1000. The total air temperature sensor 100, the total air temperature sensor 700, the total air temperature sensor 800, the total air temperature sensor 900, and the total air temperature sensor 1000 may collectively be referred to as total air temperature sensors. The total air temperature sensor 700, the total air temperature sensor 800, the total air temperature sensor 900, and/or the total air temperature sensor 1000 may include any of the baseplate 102, the housing 104, the scoop portion 106, the strut portion 108, the scoop inlet 110, the scoop outlet 112, the probe outlet 114, the sensor assembly 116, the sensor elements 118, the rim portion 122, the shoulder portion 124, the centered-through hole 126, the offset-through holes 128, the top surface 130, the flow-separation bend 132, the sensor cavity 134, the heater cavity 136, the flow duct 138, the scoop cavity 140, the flow liner 142, the fusion zone 144, the bottom lip 146, the braze joint 502, and/or the lattice structure 504. The total air temperature sensor 100, the total air temperature sensor 700, the total air temperature sensor 800, the total air temperature sensor 900, and the total air temperature sensor 1000 may be similar with variations in the orientations, sizes, dimensions, and/or position of the housing 104, the scoop portion 106, and/or the strut portion 108.

Although the bottom lip 146 of the total air temperature sensors (e.g., the total air temperature sensor 100, the total air temperature sensor 700, the total air temperature sensor 800, the total air temperature sensor 900, and/or the total air temperature sensor 1000) is described as an annular oval or an annular circle, this is not intended as a limitation of the present disclosure. For example, FIG. 9 depicts an example of the bottom lip 146 as an annular symmetric-lens. It is further contemplated that the bottom lip 146 may include any geometric shape which is annular to define the centered-through hole 126 in which the sensor assembly 116 (not depicted) is disposed. By way of another example, the bottom lip 146 may be an annular airfoil. Thus, the bottom lip 146 may be an annular oval, an annular circle, an annular airfoil, an annular symmetric-lens, or the like.

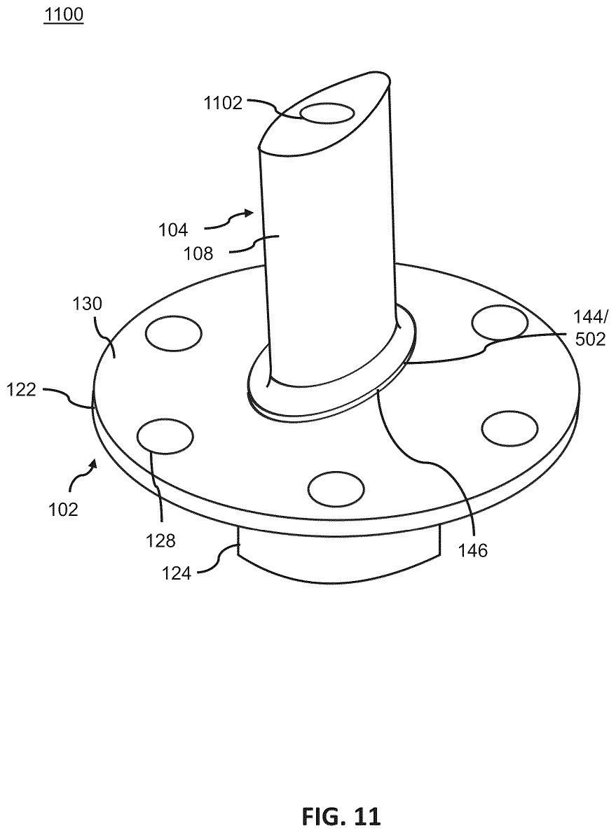

FIG. 11 depicts an outside air temperature sensor 1100 (OAT sensor), in accordance with one or more embodiments of the present disclosure. The embodiments and the enabling technology of the total air temperature sensor 100, the total air temperature sensor 700, the total air temperature sensor 800, the total air temperature sensor 900, and/or the total air temperature sensor 1000 is incorporated herein by reference as to the outside air temperature sensor 1100.

The outside air temperature sensor 1100 may include the baseplate 102, the housing 104, the strut portion 108, the probe outlet 114 (not depicted), the sensor assembly 116 (not depicted), the sensor elements 118 (not depicted), the rim portion 122, the shoulder portion 124, the centered-through hole 126 (not depicted), the offset-through holes 128, the top surface 130, the sensor cavity 134 (not depicted), the fusion zone 144, the bottom lip 146, the additional offset-through holes 302 (not depicted), the braze joint 502, and/or the lattice structure 504 (not depicted).

The strut portion 108 may define a strut inlet 1102. The bottom lip 146 and the strut inlet 1102 may be disposed at opposing ends of the strut portion 108. The probe outlet 114 (not depicted), the sensor cavity 134 (not depicted), and/or the strut inlet 1102 may be fluidically coupled within the housing 104.

As depicted, the bottom lip 146 of the outside air temperature sensor 1100 may be an annular airfoil, although this is not intended as a limitation of the present disclosure. It is further contemplated that the bottom lip 146 of the outside air temperature sensor 1100 may be an annular oval, an annular circle, an annular airfoil, an annular symmetric-lens, or the like.

The sensor assembly 116 (not depicted) may generate an outside air temperature measurement based on the flow of the air 101 (not depicted). Outside air temperature may refer to a temperature of air outside or around the aircraft 200 which is not affected by the passage of the aircraft 200.

The outside air temperature sensor 1100 may be seated on and coupled to the fuselage 202. For example, the baseplate 102 may seat the outside air temperature sensor 1100 on and couple to the fuselage 202. The probe outlet 114 and/or the strut inlet 1102 may be disposed outside of the fuselage 202.

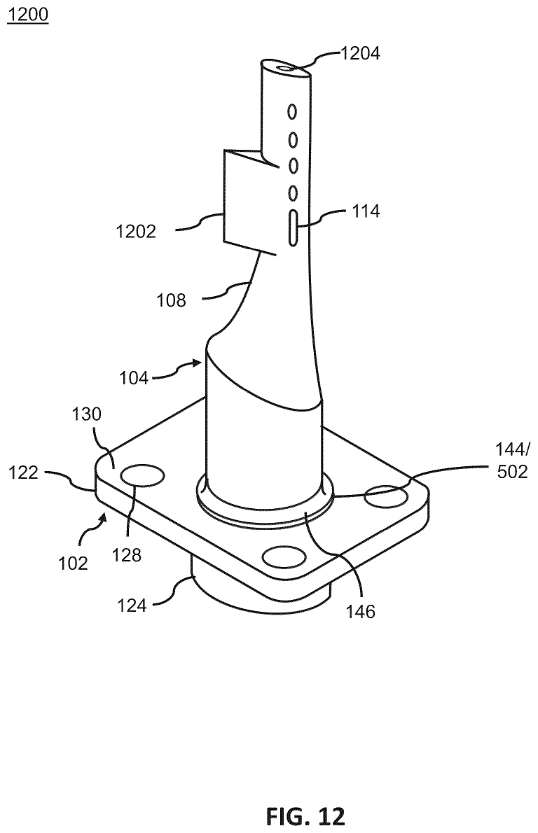

FIG. 12 depicts an engine temperature sensor 1200, in accordance with one or more embodiments of the present disclosure. The embodiments and the enabling technology of the total air temperature sensor 100, the total air temperature sensor 700, the total air temperature sensor 800, the total air temperature sensor 900, the total air temperature sensor 1000, and/or the outside air temperature sensor 1100 are incorporated herein by reference as to the engine temperature sensor 1200.

The engine temperature sensor 1200 may include the baseplate 102, the housing 104, the strut portion 108, the probe outlet 114, the sensor assembly 116 (not depicted), the sensor elements 118 (not depicted), the rim portion 122, the shoulder portion 124, the centered-through hole 126 (not depicted), the offset-through holes 128, the top surface 130, sensor cavity 134, the fusion zone 144, the bottom lip 146, the additional offset-through holes 302 (not depicted), the braze joint 502, and/or the lattice structure 504 (not depicted).

The engine temperature sensor 1200 may or may not include the scoop portion 106, the scoop inlet 110, the scoop outlet 112, the flow-separation bend 132, the heater cavity 136, and/or the scoop cavity 140.

The strut portion 108 may include a wedge extension 1202 and/or a strut inlet 1204. The wedge extension 1202 may be a leading edge of the engine temperature sensor 1200. The bottom lip 146 and the strut inlet 1204 may be disposed at opposing ends of the strut portion 108. The wedge extension 1202 may be disposed between the bottom lip 146 and the strut inlet 1204. The probe outlet 114, the sensor cavity 134 (not depicted), and/or the strut inlet 1204 may be fluidically coupled within the housing 104. The probe outlet 114 may be a slotted outlet.

The sensor assembly 116 (not depicted) may generate an engine temperature measurement. The engine temperature may refer to a temperature of a turbine engine (not depicted) of the aircraft 200. The sensor assembly 116 (not depicted) may be coupled to the turbine engine.

Referring generally again to the figures. The embodiments and the enabling technology of the of the fusion zone 144 and/or the braze joint 502 may apply to any temperature sensor (e.g., the total air temperature sensor 100, the total air temperature sensor 700, the total air temperature sensor 800, the total air temperature sensor 900, the total air temperature sensor 1000, the outside air temperature sensor 1100, engine temperature sensor 1200, or the like). The temperature sensor may include the housing 104 with the strut portion 108 and the rim portion 122 which is one of fused or brazed to the top surface of the rim portion 122 of the baseplate 102. The bottom lip 146 may abut and be one of fused to the top surface 130 by the fusion zone 144 or brazed to the top surface 130 by the braze joint 502. The portion or the entirety of the top surface 130 may be one of fused to the bottom lip 146 by the fusion zone 144 or brazed to the bottom lip 146 by the braze joint 502. For example, only a portion of the top surface 130 may be one of fused to the bottom lip 146 by the fusion zone 144 or brazed to the bottom lip 146 by the braze joint 502. By way of another example, an entirety of the top surface 130 may be one of fused to the bottom lip 146 by the fusion zone 144 or brazed to the bottom lip 146 by the braze joint 502. The sensor assembly 116 may generate any temperature measurements, such as, but not limited to, the total air temperature measurement, the outside air temperature measurement, an engine temperature measurement, or the like.

The fusion zone 144 and/or the braze joint 502 may provide several advantages, such as, improve a strut-to-baseplate joint strength, increase repeatability, and reduce the amount of skilled labor that is needed to complete a manufacture of any of the temperature sensors.

Although the rim portion 122, the shoulder portion 124, and/or the top surface 130 are described as being circular, this is not intended as a limitation of the present disclosure. The rim portion 122, the shoulder portion 124, and/or the top surface 130 of any of the temperature sensors may include any geometric shape through the axial length, such as, but not limited to, a circle, a rectangle (e.g., a square, an oblong rectangle), a rounded rectangle, or the like. For example, FIG. 12 depicts the rim portion 122 and the top surface 130 as a rounded rectangle.

The shoulder portion 124 of any of the temperature sensors may be smaller than and axially extend from the rim portion 122. For example, the shoulder portion 124 may be smaller than and axially extend from the rim portion 122 regardless of the shape of the rim portion 122 and/or the shoulder portion 124.

The portion or the entirety of the top surface 130 may be one of fused to the bottom lip 146 by the fusion zone 144 or brazed to the bottom lip 146 by the braze joint 502 regardless of the shape of the rim portion 122 and/or the top surface 130. For example, the shape of the bottom lip 146 may be adjusted to match the shape of the rim portion 122 and/or the top surface 130 where the entirety of the top surface 130 is one of fused to the bottom lip 146 by the fusion zone 144 or brazed to the bottom lip 146 by the braze joint 502. Thus, the bottom lip 146 may include a matching shape (e.g., circle, rectangle, rounded rectangle, or the like) as the top surface 130.

Although the top surface 130 is described as planar, this is not intended as a limitation of the present disclosure. It is contemplated that the top surface 130 may be curved (not depicted). For example, the top surface 130 may be one-dimensionally curved or two-dimensionally curved. The bottom lip 146 may abut and be one of fused to the top surface 130 by the fusion zone 144 or brazed to the top surface 130 by the braze joint 502 where the top surface 130 is curved.

It is further contemplated that each of the embodiments of the methods described above may include any other step(s) of any other method(s) described herein. The methods may include one or more secondary processing steps. The secondary processing steps may be performed after the additive manufacturing. The secondary processing steps may include an annealing process, a heat treat process, and/or a hot isostatic pressing (HIP) process to improve the mechanical properties. The secondary processing steps may include removing surface oxidation using a process such as chemical etching, machining, buffing, or grit blasting. The secondary processing steps may also include applying a corrosion resistant topcoat. The corrosion resistant topcoat can be applied via electroplating, chemical vapor deposition, or any other method known to those of skill in the art to apply a corrosion resistant topcoat to another surface.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The previous description is presented to enable one of ordinary skill in the art to make and use the invention as provided in the context of a particular application and its requirements. As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed:

1. A temperature sensor comprising:
a baseplate comprising a rim portion and a shoulder portion, wherein the shoulder portion is smaller than and axially extends from the rim portion, wherein the rim portion comprises a top surface, wherein the rim portion and the shoulder portion define a centered-through hole, wherein the baseplate is made of a first base metal;
a housing comprising a strut portion, wherein the strut portion defines a probe outlet and a sensor cavity, wherein the probe outlet and the sensor cavity are fluidically coupled within the housing, wherein the strut portion comprises a bottom lip, wherein the housing is made of a second base metal, wherein the housing is formed with a plurality of layers, wherein the plurality of layers are stacked axially from the baseplate up to a distal end of the housing; and
a sensor assembly, wherein the sensor assembly is disposed within the centered-through hole and the sensor cavity, wherein the sensor assembly is configured to generate a temperature measurement;
wherein the bottom lip abuts and is fused to the top surface by a fusion zone.

2. The temperature sensor of claim 1, wherein only a portion of the top surface is fused to the bottom lip by the fusion zone.

3. The temperature sensor of claim 1, wherein an entirety of the top surface is fused to the bottom lip by the fusion zone, wherein the rim portion defines a plurality of offset-through holes, wherein the bottom lip defines a plurality of additional offset-through holes, and wherein the plurality of offset-through holes and the plurality of additional offset-through holes are coincident.

4. The temperature sensor of claim 1, wherein the fusion zone is an alloy of the first base metal and the second base metal, and wherein the fusion zone does not include any metal other than the first base metal and the second base metal.

5. The temperature sensor of claim 4, wherein a depth of the fusion zone is greater than 250 micrometers.

6. The temperature sensor of claim 1, wherein the bottom lip is one of an annular oval, an annular circle, an annular airfoil, or an annular symmetric-lens.

7. The temperature sensor of claim 1, wherein the first base metal is different than the second base metal.

8. The temperature sensor of claim 1, wherein the temperature sensor is a total air temperature sensor, wherein the housing comprises a scoop portion, wherein the scoop portion extends from the strut portion, wherein the strut portion is disposed between the scoop portion and the baseplate, wherein the scoop portion defines a scoop inlet, a scoop outlet, and a scoop cavity, wherein the scoop inlet, the scoop outlet, the probe outlet, the sensor cavity, and the scoop cavity are fluidically coupled within the housing, and wherein the sensor assembly is configured to generate a total air temperature measurement.

9. The temperature sensor of claim 1, wherein the temperature sensor is an outside air temperature sensor, wherein the strut portion comprises a strut inlet, wherein the bottom lip and the strut inlet are disposed at opposing ends of the strut portion, wherein the probe outlet, the sensor cavity, and the strut inlet are fluidically coupled within the housing, and wherein the sensor assembly is configured to generate an outside air temperature measurement.

10. The temperature sensor of claim 1, wherein the temperature sensor is an engine temperature sensor, and wherein the sensor assembly is configured to generate an engine temperature measurement.

11. A temperature sensor comprising:
a baseplate comprising a rim portion and a shoulder portion, wherein the shoulder portion is smaller than and axially extends from the rim portion, wherein the rim portion comprises a top surface, wherein the rim portion and the shoulder portion define a centered-through hole, wherein the baseplate is made of a first base metal;
a housing comprising a strut portion, wherein the strut portion defines a probe outlet and a sensor cavity, wherein the probe outlet and the sensor cavity are fluidically coupled within the housing, wherein the strut portion comprises a bottom lip, wherein the housing is made of a second base metal, wherein the housing is formed with a plurality of layers, wherein the plurality of layers are stacked axially from the baseplate up to a distal end of the housing; and
a sensor assembly, wherein the sensor assembly is disposed within the centered-through hole and the sensor cavity, wherein the sensor assembly is configured to generate a temperature measurement;
wherein the bottom lip abuts and is brazed to the top surface by a braze joint, wherein the braze joint comprises a filler metal, wherein the braze joint does not form an alloy with the first base metal and the second base metal, wherein the bottom lip comprises a lattice structure, wherein the lattice structure is formed from a subset of the plurality of layers, wherein the lattice structure abuts and is brazed to the top surface by the braze joint, and wherein the braze joint fills the lattice structure.

12. The temperature sensor of claim 11, wherein only a portion of the top surface is brazed to the bottom lip by the braze joint.

13. The temperature sensor of claim 11, wherein an entirety of the top surface is brazed to the bottom lip by the braze joint, wherein the rim portion defines a plurality of offset-through holes, wherein the bottom lip defines a plurality of additional offset-through holes, and wherein the plurality of offset-through holes and the plurality of additional offset-through holes are coincident.

14. The temperature sensor of claim 11, wherein the filler metal comprises at least one of silver, aluminum, gold, copper, zinc, tin, nickel, or an alloy thereof.

15. The temperature sensor of claim 11, wherein the lattice structure is open-cell.

16. The temperature sensor of claim 11, wherein the bottom lip is one of an annular oval, an annular circle, an annular airfoil, or an annular symmetric-lens.

17. The temperature sensor of claim 11, wherein the first base metal is different than the second base metal.

18. The temperature sensor of claim 11, wherein the temperature sensor is a total air temperature sensor, wherein housing comprises a scoop portion, wherein the scoop portion extends from the strut portion, wherein the strut portion is disposed between the scoop portion and the baseplate, wherein the scoop portion defines a scoop inlet, a scoop outlet, and a scoop cavity, wherein the scoop inlet, the scoop outlet, the probe outlet, the sensor cavity, and the scoop cavity are fluidically coupled within the housing, and wherein the sensor assembly is configured to generate a total air temperature measurement.

19. The temperature sensor of claim 11, wherein the temperature sensor is an outside air temperature sensor, wherein the strut portion comprises a strut inlet, wherein the bottom lip and the strut inlet are disposed at opposing ends of the strut portion, wherein the probe outlet, the sensor cavity, and the strut inlet are fluidically coupled within the housing, and wherein the sensor assembly is configured to generate an outside air temperature measurement.

20. The temperature sensor of claim 11, wherein the temperature sensor is an engine temperature sensor, and wherein the sensor assembly is configured to generate an engine temperature measurement.
